(19) United States
(12) Patent Application Publication
(10) Pub. No.: US 2025/0147489 A1
(43) Pub. Date: May 8, 2025

(54) DUAL-EFFECT SCHEDULING METHOD FOR HETEROGENEOUS ROBOTS IN FLEXIBLE JOB SHOP

(71) Applicant: Beijing Institute of Technology, Beijing (CN)

(72) Inventors: Bin Xin, Beijing (CN); Mengjie Jing, Beijing (CN); Sai Lu, Beijing (CN); Fang Deng, Beijing (CN); Qing Wang, Beijing (CN); Jiwei He, Beijing (CN); Yingmei He, Beijing (CN)

(21) Appl. No.: 18/940,732

(22) Filed: Nov. 7, 2024

(30) Foreign Application Priority Data
Nov. 8, 2023 (CN) 202311477216.2

(51) Int. Cl. B25J 9/16

(52) U.S. Cl. CPC G05B 19/41845; B25J 9/1661; G05B 13/04; G05B 19/41865; B25J 9/1653; B25J 9/1664; G05B 19/41895; G05B 2219/32252

(57) ABSTRACT

The present disclosure belongs to the field of flexible job shop scheduling, and relates to a dual-effect scheduling method for heterogeneous robots in a flexible job shop. In a case of strong coupling of processing and transferring, this method comprehensively considers such constraints on selection of flexible manufacturing cells (FMCs), transferring time by automatic guided vehicles (AGVs) and processing resource waste, and improves encoding schemes and genetic operators with order completion time and minimization of resource consumption as evaluation criteria. Additionally, this method can fully apply environmental characteristics of job shop to scheduling design, and automatically design more precise scheduling schemes, overcoming the deficiencies of slow response and prone to local optimal solutions existing in conventional scheduling schemes, and ensuring efficient and green operation.

### CROSS-REFERENCE TO RELATED APPLICATION

This application claims priority of Chinese Patent Application No. 202311477216.2, filed on Nov. 8, 2023, the entire contents of which are incorporated herein by reference.

### TECHNICAL FIELD

The present disclosure belongs to the field of flexible job shop scheduling, and specifically relates to a dual-effect scheduling method for heterogeneous robots in a flexible job shop.

### BACKGROUND

In response to the requirement of future manufacturing, manufacturing enterprises are required to increasingly improve process, enhance production efficiency, and reduce cost to achieve unmanned intelligent production. To provide seamless transportation of products in manufacturing environment, a potential solution emerged from the rushed industrial environment involves researching and integrating material processing system with automated guided vehicle (AGV).

With the economic advance, the demand for green development is on the rise. Accordingly, energy conservation and low carbon are incorporated as new evaluation criteria for green manufacturing in scheduling of hardware manufacturing shops, requiring a comprehensive consideration of reducing environmental cost, enhancing production efficiency, and lowering energy consumption during studying job shop scheduling problems, thereby optimizing both green and economic criteria. In the production process, the rational and prompt scheduling of automated vehicles is crucial to the acceleration of production progress, because the scheduling results can affect the allocation and consumption of resources such as processing robots and transfer vehicles.

As the production demand on modern job shops increases, the production environment has become more complex, and traditional scheduling methods fail to efficiently deal with contradictions and conflicts risen from flexible manufacturing during large-scale and multi-variety production. Such production requires flexible manufacturing cell (FMC), a technically sophisticated, automated, and integrated high-end manufacturing equipment for completing multiple processing tasks with multiple procedures and varying batches.

Therefore, on the basis of research on traditional job shop scheduling, it is necessary to incorporate the characteristics of FMC with economic and green criteria to align with development trends, which gives prominence to the importance of research on multi-robot scheduling mechanism and algorithm for FMC in modern manufacturing.

Although multi-robot scheduling for FMC is one of the cores of intelligent manufacturing, there is still a big research gap in this field. In flexible manufacturing job shops, various types of robots are widely used, including processing robots for workpiece processing and AGV for transferring workpieces between processing robots during production. To address the scheduling problem in intelligent job shops, the present disclosure provides a dual-effect scheduling method for heterogeneous robots in a flexible job shop.

### SUMMARY

To solve the technical problem that scheduling schemes designed for the joint dynamic job shop scheduling of processing robots and AGVs fail to be considered in prior art, the present disclosure provides a dual-effect scheduling method for heterogeneous robots in a flexible job shop. Compared with the traditional genetic algorithm, this method is improved in encoding schemes and genetic operators. By comprehensively considering flexible constraints on FMC, time constraints on workpiece transferring by AGV, and constraints on processing resource waste, and taking order completion time and minimization of resource consumption as evaluation criteria, an optimal scheduling scheme for intelligent job shops that satisfies demand preferences is generated, ensuring efficient and green operation of a flexible manufacturing system in multi-process and multi-variety production. Compared with the existing job shop scheduling algorithm, this method is better in scheduling results, easier to escape from local optimal solution, and stronger in global search capability. Furthermore, this method allows for the conduction of large-scale, multi-variety, and multi-process production by flexible manufacturing systems, enabling unmanned intelligent job shops and possessing tremendous development potential.

The present disclosure provides the following technical solutions.

A dual-effect scheduling method for heterogeneous robots in a flexible job shop includes the following steps:

step 1: encoding each individual in three layers using a symbolic coding method, the encoding of each individual including three layers, namely, workpiece procedure-based encoding, processing robot-based encoding, and AGV-based encoding;

step 2: acquiring processing robot information, AGV information and to-be-processed workpiece information, integrating two objective functions for respectively minimizing order completion time and minimizing resource consumption into a single composite function using a weighted optimization method, and designing a fitness function;

step 3: calculating fitness of each individual encoded in step 1 using the fitness function designed in step 2, and selecting individuals for the next generation according to fitness values using a roulette wheel selection method with an elitism strategy;

step 4: performing crossover operation on the workpiece procedure-based encoding and the AGV-based encoding of the individual in step 1 using precedence operation crossover (POX), and performing two-point crossover operation on the processing robot-based encoding of the individual;

step 5: performing swap mutation operation on the workpiece procedure-based encoding and the AGV-based encoding of the individual in step 1, and performing uniform mutation operation on the processing robot-based encoding of the individual; and

step 6: together forming the individual selected in step 3, the individual after the crossover operation in step 4, and the individual after the mutation operation in step 5 into a new population for the next generation, repeating steps 3 to 5 for individuals in the new population for the next generation to obtain optimal scheduling schemes and fitness values, and selecting a suitable scheduling scheme according to the demand preferences to perform dual-effect scheduling on heterogeneous robots in a flexible job shop.

In step 1, the first layer of encoding is based on workpiece procedure, for clarifying the order of various workpieces and various procedures in a processing scheme; each gene of the individual represents a specific procedure of a specific workpiece; various procedures of a workpiece are represented by the order in which the workpiece appears in the individual; and the nth presence of a specific workpiece in the individual represents the nₜₕ procedure of the specific workpiece;

the second layer of encoding is based on processing robot, for clarifying the order of selected processing robots corresponding to various procedures of workpieces in the processing scheme; each gene of the individual represents a corresponding processing robot selected for a specific procedure of a specific workpiece; and the order of genes follows the order of processing workpiece numbers and the order of procedure numbers of a specific workpiece; and

the third layer of encoding is based on AGV, for clarifying the order of AGVs corresponding to various workpiece procedures in the processing scheme; each gene of the individual represents an AGV number corresponding to a specific procedure of transferring a specific workpiece; and the order of genes corresponds to the order of the workpiece procedure-based encoding.

In step 2, the processing robot information includes: the number of processing robots, the process processing capability of processing robots, and fixed-point positions of processing robots; the AGV information includes: the number of AGVs, the running speed of AGVs, and initial positions of AGVs; and the to-be-processed workpiece information includes: the number of workpieces to be processed, the number of procedures of the workpieces to be processed, and available processing robots and processing time for each procedure; and the fitness function is defined as:

$$F ( k ) = ω \times \frac{{f}_{1 m ax} - {f}_{1} ( k )}{{f}_{1 m ax} - {f}_{1 m i n}} + ( 1 - ω ) \frac{{f}_{2 m ax} - {f}_{2} ( k )}{{f}_{2 m ax} - {f}_{2 m i n}} , ( k = 1 , 2 , … , N )$$

where F(k) is a fitness value of a kₜₕ individual; ω is a weight coefficient for completion time, ranging from [0,1], and the allocation of weight is determined by a decision-maker of a job shop; in a case that 0.6≤ω≤1, the job shop operates in an efficient processing mode; in a case that 0.4≤ω≤0.6, the job shop operates in a comprehensive processing mode; and in a case that 0.2≤ω≤0.4, the job shop operates in a green processing mode; f₁ₘₐₓ is a maximum order completion time in a job shop of a current population; f₁(k) is an order completion time in a job shop of the kₜₕ individual; f₁ₘᵢₙ is a minimum order completion time in the job shop of the current population; f₂ₘₐₓ is a maximum energy consumption of the current population; f₂(k) is energy consumption of the kₜₕ individual; f₂ₘᵢₙ is a minimum energy consumption of the current population; and N is the total number of individuals in the current population.

In step 3, individuals with the highest fitness values in the current population are elite individuals; the first quarter of individuals with the highest fitness values in the current population are kept from undergoing the roulette wheel selection, and the remaining three-quarters undergo the roulette wheel selection, crossover, and mutation to generate a new generation of population; and if a fitness value of an optimal individual in the new generation of population is better than that of a reserved parent, it indicates that the population has been optimized, and the worst individual in offspring is replaced with the reserved elite individual.

In step 4, a method for performing crossover operation on the workpiece procedure- based encoding of the individual using POX is as follows:

randomly dividing all workpieces into two sets Q₁ and Q₂; copying workpieces of parent P₁ that are contained in Q₁ to corresponding positions in an offspring individual J₁, copying workpieces of parent P₂ that are contained in Q₂ to corresponding positions in an offspring individual J₂, and fixing the position of each gene in the individual; and copying workpieces of the parent P₂ that are contained in Q₂ to corresponding positions in the offspring individual J₁, and copying workpieces of the parent P₁ that are contained in Q₁ to corresponding positions in the offspring individual J₂, and keeping the order of genes to obtain two offspring individuals J₁ and J₂ after crossover.

In step 4, a method for performing crossover operation on the AGV-based encoding of the individual using POX is as follows:

randomly dividing all AGVs into two sets Q₁ and Q₂; copying workpieces of parent P₁ that are contained in Q₁ to corresponding positions in an offspring individual C₁, copying workpieces of parent P₂ that are contained in Q₂ to corresponding positions in an offspring individual C₂, and fixing the position of each gene in the individual; and copying workpieces of the parent P₂ that are contained in Q₂ to corresponding positions of the offspring individual C₁, and copying workpieces of the parent P₁ that are contained in Q₁ to corresponding positions of the offspring individual C₂, keeping the order of genes to obtain two offspring individuals C₁ and C₂ after crossover.

In step 4, a method for performing two-point crossover operation on the processing robot-based encoding of the individual is as follows:

selecting two different points p₁ and p₂ as crossover points, and swapping genes g₁ and g₂ in p₁ and p₂ of two individuals respectively.

In step 5: a method for performing swap mutation operation on the workpiece procedure-based encoding of the individual is as follows: selecting two different random numbers within the length of two procedures, and swapping genes of the two procedures;

a method for performing swap mutation operation on the AGV-based encoding is as follows: selecting two different random numbers within the length of two AGVs, and swapping genes of the two AGVs; and

a method for performing uniform mutation operation on the processing robot-based encoding of the individual is as follows: randomly selecting a procedure, directly returning without changing the gene if only one robot is selectable for the procedure, otherwise, randomly generating a serial number different form the currently selected machine within a selectable machine set for the procedure, and performing swap.

In step 6, a suitable scheduling scheme is selected according to demand preferences, the demand preference referring to the balance between the two objectives of order completion time and energy consumption, a desired scheme is selected and implemented, and a method for obtaining the optimal scheduling scheme is as follows:

gradually iterating, and obtaining the optimal scheduling scheme in a case that the change in fitness values is less than a set threshold or the number of generations is greater than the set number of iterations

The present disclosure has the following beneficial effects over the prior art.

Firstly, the flexible constraints on FMC, time constraints on workpiece transferring by AGV, and constraints on processing resource waste are comprehensively considered in the present disclosure, making the method of the present disclosure more suitable for the integrated scheduling of processing robots and AGV in flexible manufacturing job shops than traditional job shop scheduling method.

Secondly, the order completion time and minimization of resource consumption are taken as evaluation criteria in the present disclosure, allowing customers to select processing modes as required, thus generating the optimal scheduling scheme for intelligent job shops, which ensures the efficient and green operation of flexible manufacturing systems for multi-process and multi-variety production.

Thirdly, in the design process of the method of the present disclosure, the processing time for some processing robots is a random number, proving that the scheduling scheme generated by this method allows customers to customize personalized processing flow as required.

Fourthly, compared with other scheduling methods, the method proposed in the present disclosure exhibits faster global convergence and prevents the illegal and infeasible solutions after crossover operation, ensuring the feasibility and validity of the solutions corresponding to the crossover offspring. Additionally, this method can ensure that the number of AGVs remains unchanged after crossover and mutation operation.

Fifthly, the method of the present disclosure allows for the flexible manufacturing system conducting large-scale, multi-variety, and multi-process production, enabling unmanned intelligent job shops. Therefore, this method has great potential for development.

### BRIEF DESCRIPTION OF THE DRAWINGS

FIG. 1 shows the workpiece procedure-based encoding;

FIG. 2 shows the processing robot-based encoding;

FIG. 3 is a schematic diagram showing three-layer encoding of individual;

FIG. 4 shows the change of an optimal fitness function;

FIG. 5 is a flowchart showing the crossover operation on procedure-based encoding;

FIG. 6 is a flowchart showing crossover operation on AGV-based encoding;

FIG. 7 is a diagram showing a simulation operation interface of a job shop;

FIG. 8 is a schematic diagram showing the layout of the job shop;

FIG. 9 is a schematic diagram showing processing robots in the job shop;

FIG. 10 is a schematic diagram showing the AGV charging process in the job shop;

FIG. 11 is a schematic diagram showing AGV and processing robot in the job shop;

FIG. 12 is a flowchart showing online scheduling algorithm for processing tasks of processing robots;

FIG. 13A is a processing flowchart of a flexible manufacturing job shop, showing that AGV heads to the feed-in area to pick up materials;

FIG. 13B is a processing flowchart of a flexible manufacturing job shop, showing that the AGV is picking up materials;

FIG. 13C is a processing flowchart of a flexible manufacturing job shop, showing that the AGV delivers materials to a processing robot for processing;

FIG. 13D is a processing flowchart of a flexible manufacturing job shop, showing that the processing robot is processing Workpiece I;

FIG. 13E is a processing flowchart of a flexible manufacturing job shop, showing that Workpiece I is stored in the buffer area for finished products after processing;

FIG. 13F is a processing flowchart of a flexible manufacturing job shop, showing that the AGV is transferring the processed Workpiece I;

FIG. 13G is a processing flowchart of a flexible manufacturing job shop, showing that the AGV picks up Workpiece I;

FIG. 13H is a processing flowchart of a flexible manufacturing job shop, showing that the AGV transfers Workpiece I to the processing robot for the next procedure;

FIG. 13I is a processing flowchart of a flexible manufacturing job shop, showing that the AGV heads to the charging station for charging;

FIG. 13J is a processing flowchart of a flexible manufacturing job shop, showing that the AGV is undergoing charging;

FIG. 13K is a processing flowchart of a flexible manufacturing job shop, showing that Workpiece I after the final procedure is sent to the shipment area; and

FIG. 13L is a processing flowchart of a flexible manufacturing job shop, showing that all workpieces have been processed;

FIG. 14 is a Gantt diagram showing an optimal scheduling scheme based on genetic algorithm (ω=0.8);

FIG. 15 shows an iterative change curve of fitness value (ω=0.8);

FIG. 16 is a Gantt diagram showing an optimal scheduling scheme based on genetic algorithm (ω=0.2);

FIG. 17 shows an iterative change curve of fitness value (ω=0.2);

FIG. 18 is a Gantt diagram showing an optimal scheduling scheme based on genetic algorithm (ω=0.5); and

FIG. 19 shows an iterative change curve of fitness value (ω=0.5).

### DETAILED DESCRIPTION

The present disclosure is further described by reference to the accompanying drawings and examples below.

A dual-effect scheduling method for heterogeneous robots in a flexible job shop includes the following steps.

Step 1: each individual is encoded in three layers using a symbolic coding method, with the encoding of each individual including three layers, namely, workpiece procedure-based encoding, processing robot-based encoding, and AGV-based encoding.

Step 2: processing robot information, AGV information and to-be-processed workpiece information are acquired, two objective functions for respectively minimizing order completion time and minimizing resource consumption are integrated into a single composite function using a weighted optimization method, and a fitness function is designed.

Step 3: fitness of each individual encoded in step 1 is calculated using the fitness function designed in step 2, and individuals for the next generation are selected according to fitness values using a roulette wheel selection method with an elitism strategy. Step 4: crossover operation is performed on the workpiece procedure-based encoding and the AGV-based encoding of the individual in step 1 using POX, and two-point crossover operation is performed on the processing robot-based encoding of the individual.

Step 5: swap mutation operation is performed on the workpiece procedure-based encoding and the AGV-based encoding of the individual in step 1, and uniform operation is performed on the processing robot-based encoding of the individual.

Step 6: the individual selected in step 3, the individual after the crossover operation in step 4, and the individual after the mutation operation in step 5 are together formed into a new population for the next generation, steps 3 to 5 are repeated for individuals in the new population for the next generation to obtain optimal scheduling schemes and fitness values, and a suitable scheduling scheme is selected according to the demand preferences to perform dual-effect scheduling on heterogeneous robots in a flexible job shop.

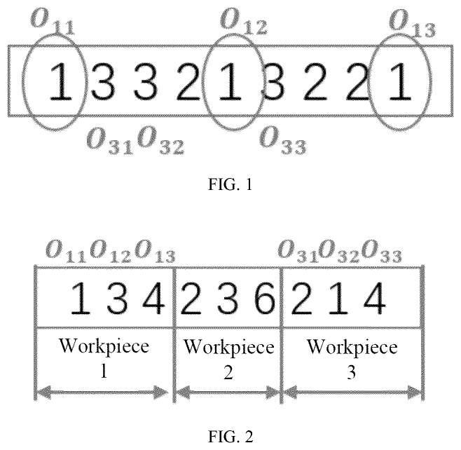

In step 1, the first layer of encoding is based on workpiece procedure, for clarifying the order of various workpieces and various procedures in a processing scheme. Each gene of the individual represents a specific procedure of a specific workpiece; various procedures of a workpiece are represented by the order in which the workpiece appears in the individual; and the nth presence of a specific workpiece in the individual represents the nₜₕ procedure of the specific workpiece. For example, for a processing order containing three workpieces to be processed {J₁,J₂,J₃}, with each workpiece containing three procedures, the number for each workpiece is multiplied by the corresponding number for procedure, and the result serves as a set of numbers. Those numbers are randomly arranged to obtain workpiece procedure-based encoding, as shown in FIG. 1.

In FIG. 1, the first gene 1 represents the first procedure of the processing workpiece J₁, the second gene 3 represents the first procedure of the processing workpiece J₃, the third gene 3 represents the second procedure of the processing workpiece J₃, and so on. Therefore, the order of procedures of the processing workpiece in a processing scheme corresponding to an individual shown in FIG. 1 is {P₁₁, P₃₁, P₃₂, P₂₁, P₁₂, P₃₃, P₂₂, P₂₃, P₁₃}.

The second layer of encoding is based on processing robot, for clarifying the order of selected processing robots corresponding to various procedures of workpieces in the processing scheme. Each gene of the individual represents a corresponding processing robot selected for a specific procedure of a specific workpiece; and the order of genes follows the order of processing workpiece numbers and the order of procedure numbers of a specific workpiece. Similarly, taking an order containing three workpieces to be processed as an example, with each workpiece containing three procedures, assuming that five processing robots {R₁, R₂, R₃, R₄, R₆} are used for processing, an example showing processing robot-based encoding for a particular processing scheme is shown in FIG. 2.

In FIG. 2, the first gene 1 represents that the processing procedure P₁₁ selects the processing robot R₁, the second gene 3 represents that the processing procedure P₁₂ selects the processing robot R₃, and the fifth gene 3 represents that the processing procedure P₂₂ selects the processing robot R₃. Therefore, the order of processing robots corresponding to each processing procedure of each workpiece in the processing scheme corresponding to the individual in the figure is as follows: {R₁, R₃, R₄, R₂, R₃, R₆, R₂, R₁, R₄}, that is, the workpiece J₁ is processed sequentially by processing robots R₁, R₃, and R₄, the workpiece J₂ is processed sequentially by processing robots R₂, R₃, and R₆, and the workpiece J₃ is processed sequentially by processing robots R₂, R₁, and R₄.

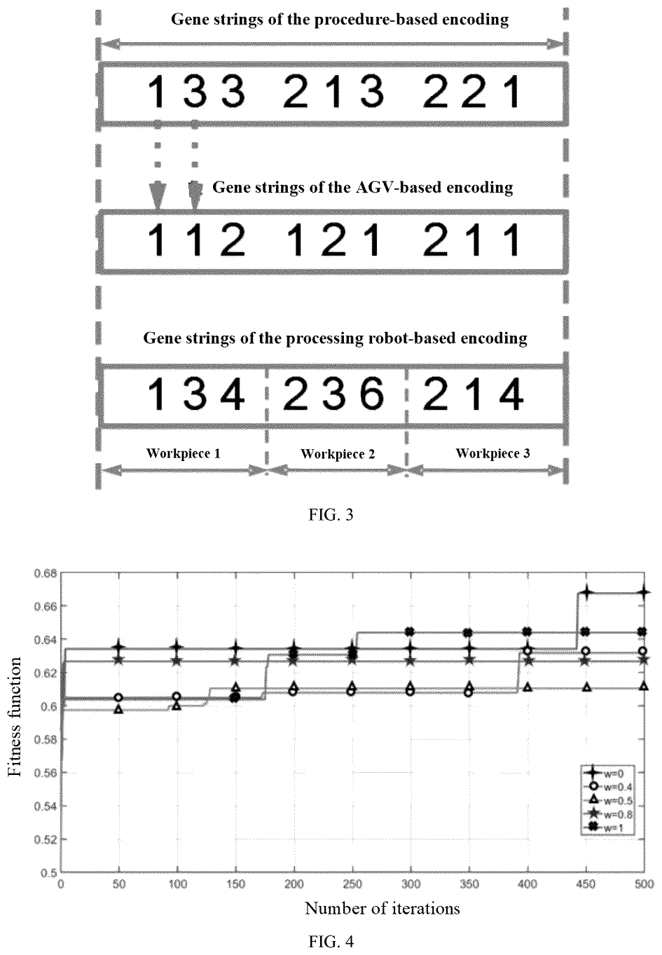

The third layer of encoding is based on AGV, for clarifying the order of AGVs corresponding to various workpiece procedures in the processing scheme. Each gene of the individual represents an AGV number corresponding to a specific procedure for transferring a specific workpiece; and the order of genes corresponds to the order of the workpiece procedure-based encoding. Similarly, taking an order containing three workpieces to be processed as an example, with each workpiece containing three procedures, assuming that two AGVs {A₁, A₂} are used for transferring, for the AGV-based encoding in a specific processing scheme, the three layers of encoding are summarized to obtain three gene strings, and the corresponding relationship of the three layers of encoding is shown in FIG. 3. The length of the encoding strings is the same, which represents the total number of processes. The order of the gene string of the AGV-based encoding corresponds one-to-one with that of the procedure-based encoding, and the gene strings of the processing robot-based encoding are arranged following the order of the workpiece.

In FIG. 3, the order of AGVs corresponds to the order of the workpiece procedure {P₁₁, P₃₁, P₃₂, P₂₁, P₁₂, P₃₃, P₂₂, P₂₃, P₁₃}. The first gene 1 represents that A₁ is responsible for transferring the workpiece corresponding to the processing procedure P₁₁, and the second gene 1 represents that A₁ is responsible for transferring the workpiece corresponding to the processing procedure P₃₁. Therefore, the order of AGVs shown in the figure corresponds to the order of processing procedures for each workpiece in the processing scheme is {A₁, A₁, A₂, A₁, A₂, A₁, A₂, A₁, A₁}.

In step 2, the processing robot information includes: the number of processing robots, the process processing capability of processing robots, and fixed-point positions of processing robots; the AGV information includes: the number of AGVs, the running speed of AGVs, and initial positions of AGVs; and the to-be-processed workpiece information includes: the number of workpieces to be processed, the number of procedures of the workpieces to be processed, and available processing robots and processing time for each procedure; and the fitness function is defined as:

$$F ( k ) = ω \times \frac{{f}_{1 m ax} - {f}_{1} ( k )}{{f}_{1 m ax} - {f}_{1 m i n}} + ( 1 - ω ) \frac{{f}_{2 m ax} - {f}_{2} ( k )}{{f}_{2 m ax} - {f}_{2 m i n}} , ( k = 1 , 2 , … , N )$$

where F(k) is a fitness value of a kₜₕ individual; ω is a weight coefficient for completion time, ranging from [0,1], and the allocation of weight is determined by a decision-maker of a job shop; in a case that 0.6≤ω≤1, the job shop operates in an efficient processing mode; in a case that 0.4≤ω≤ 0.6, the job shop operates in a comprehensive processing mode; and in a case that 0.2≤ω≤0.4, the job shop operates in a green processing mode; f₁ₘₐₓ is a maximum order completion time in the job shop of a current population; f₁(k) is an order completion time in the job shop of the kₜₕ individual; f₁ₘᵢₙ is a minimum order completion time in the job shop of the current population; f₂ₘₐₓ is a maximum energy consumption of the current population; f₂(k) is energy consumption of the kₜₕ individual; f₂ₘᵢₙ is a minimum energy consumption of the current population; and N is the total number of individuals in the current population.

FIG. 4 shows the change curves of the optimal fitness function, which are plotted when ω is 0, 0.4, 0.5, 0.8, and 1, respectively. It can be seen from FIG. 4 that, undergoing iterations, the fitness of the population shows an upward trend, and the stepwise increases in the curve reflect the process of the genetic algorithm searching for the optimal solution. However, it can also be found from the figure that when ω=0.8, the corresponding curve changes only once, indicating that the optimal solution is found through only one search. However, this solution may be an optimal solution or a local optimal solution, showing the limitation of the genetic algorithm. At the same time, it can also be found that as ω increases, the initial value of the curve tends to decrease.

In step 3, individuals with the highest fitness values in the current population are elite individuals. The first quarter of individuals with the highest fitness values in the current population are kept from undergoing the roulette wheel selection, and the remaining three-quarters undergo the roulette wheel selection, crossover, and mutation to generate a new generation of population. If a fitness value of an optimal individual in the new generation of population is better than that of a reserved parent, it indicates that the population has been optimized, and the worst individual in offspring is replaced with the reserved elite individual. This selection method allows for better convergence to the global optimal solution, avoiding the loss of the global optimal solution caused by the subsequent crossover and mutation operations. In addition, this selection method improves the search speed of the genetic algorithm, enabling a faster global convergence.

In step 4, a method for performing crossover operation on the workpiece procedure-based encoding of the individual using POX is as follows.

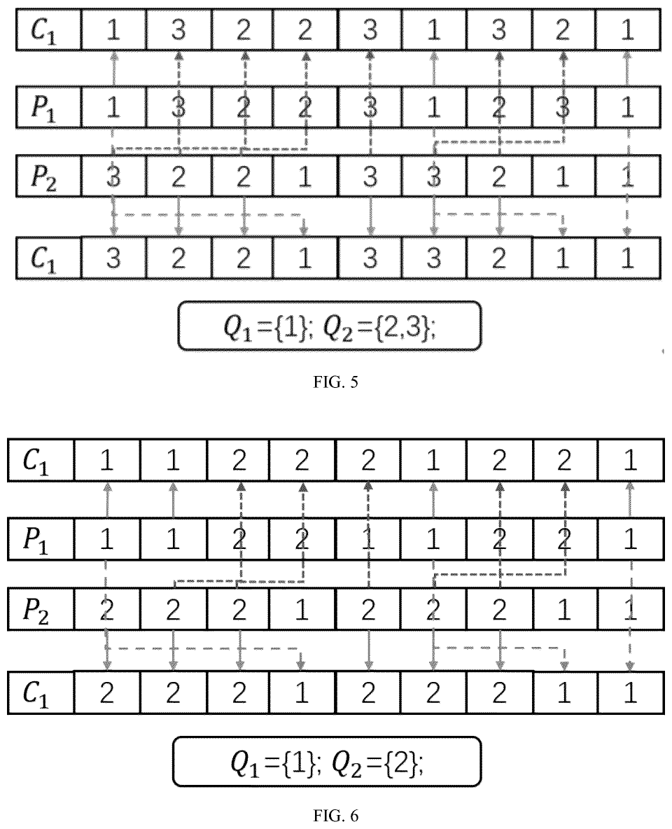

All workpieces are randomly divided into two sets Q₁ and Q₂. Workpieces of parent P₁ that are contained in Q₁ are copied to corresponding positions in an offspring individual C₁, workpieces of parent P₂ that are contained in Q₂ are copied to corresponding positions in an offspring individual C₂, and the position of each gene in the individual is fixed. Workpieces of the parent P₂ that are contained in Q₂ are copied to corresponding positions in the offspring individual C₁, and workpieces of the parent P₁ that are contained in Q₁ are copied to corresponding positions in the offspring individual C₂, and the order of genes is kept to obtain two offspring individuals C₁ and C₂ after crossover, as shown in FIG. 5.

In step 4, a method for performing crossover operation on the AGV-based encoding of the individual using POX is as follows.

All AGVs are randomly divided into two sets Q₁ and Q₂. Workpieces of parent P₁ that are contained in Q₁ are copied to corresponding positions in an offspring individual C₁, workpieces of parent P₂ that are contained in Q₂ are copied to corresponding positions in an offspring individual C₂, and the position of each gene in the individual is fixed. Workpieces of the parent P₂ that are contained in Q₂ are copied to corresponding positions of the offspring individual C₁, and workpieces of the parent P₁ that are contained in Q₁ are copied to corresponding positions of the offspring individual C₂, and the order of genes is kept to obtain two offspring individuals C₁ and C₂ after crossover, as shown in FIG. 6.

In step 4, a method for performing two-point crossover operation on the processing robot-based encoding of the individual is as follows.

Two different points p₁ and p₂ are selected as crossover points, and genes g₁ and g₂ in p₁ and p₂ of two individuals are swapped, respectively. This crossover method can prevent the illegal and infeasible solutions after crossover operation, ensure the feasibility and validity of the solutions corresponding to the crossover offspring, and guarantees that the number of AGVs remains unchanged after crossover operation.

In step 5: a method for performing swap mutation operation on the workpiece procedure-based encoding of the individual is as follows. Two different random numbers within the length of two procedures are randomly selected, and genes of the two procedures are swapped.

A method for performing swap mutation operation on the AGV-based encoding is as follows. Two different random numbers within the length of two AGVs are selected, and genes of the two AGVs are swapped.

A method for performing uniform mutation operation on the processing robot-based encoding of the individual is as follows. A procedure is randomly selected. Direct returning is performed without changing the gene if only one machine is selectable for the procedure, otherwise, a serial number different from a currently selected machine is randomly generated within a selectable machine set of the procedure, and swap is performed.

This mutation method can ensure that the number of AGVs remains unchanged after the mutation

In step 6, a suitable scheduling scheme is selected according to demand preferences, the demand preference referring to the balance between the two objectives of order completion time and energy consumption, a desired scheme is selected and implemented, and a method for obtaining the optimal scheduling scheme is as follows.

Gradual iteration is performed, and the optimal scheduling scheme is obtained in a case that the change in fitness values is less than a set threshold or the number of generations is greater than the set number of iterations

### Embodiment

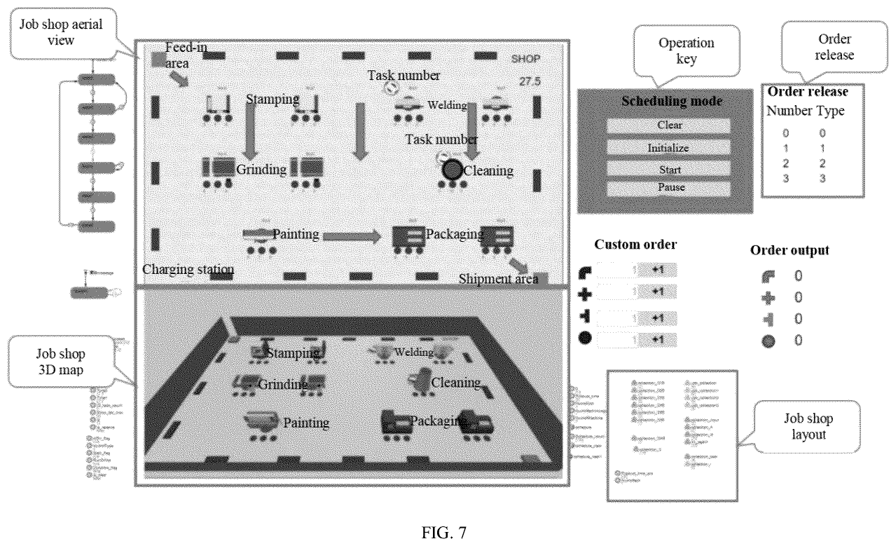

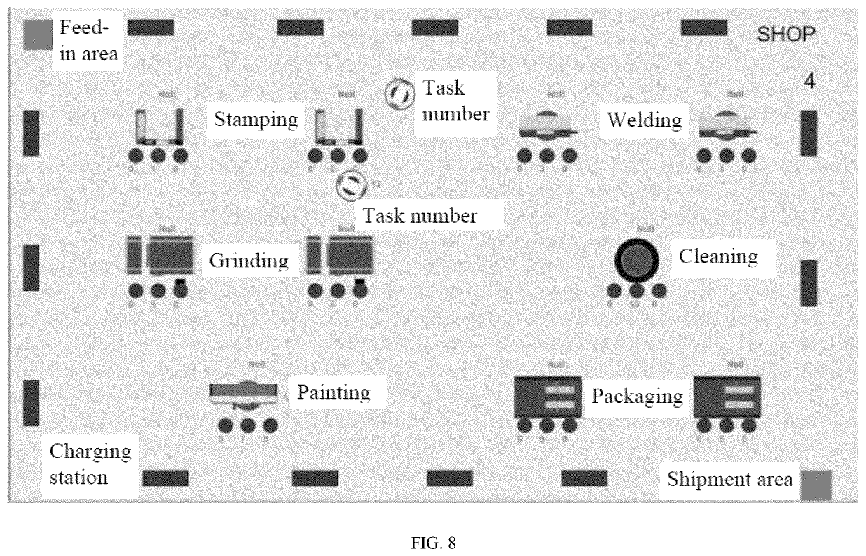

In this section, the effect achieved by the present disclosure is explained through simulation data experiments. To evaluate the performance of the proposed detection method, a simulation operation interface for a flexible manufacturing job shop is designed using AnyLogic simulation software, shown in FIG. 7. A simulation job shop map and an actual job shop map is in a scale of 1:10, meaning that every 10 units represent 1 meter.

The layout of processing robots and charging stations in the job shop is shown in FIG. 8. From top to bottom and left to right, there are two stamping robots mainly engaged in stamping processes including punching, bending, shearing, deep drawing, bulging, spinning, and straightening, two welding robots mainly engaged in welding metals or other thermoplastic materials through heating, high temperature or high pressure, two grinding and polishing robots mainly engaged in treating surface burrs of hardware workpieces to make them smoother, one cleaning robot, one painting robot, and two packaging robots. The rated power, no-load power, and setup time for each processing robot are shown in Table 1.

TABLE 1
Processing power (kW)/setup time (min) of processing robots

| | Robot number | | | | | | | | | |
|---|---|---|---|---|---|---|---|---|---|---|
| | 1 | 2 | 3 | 4 | 5 | 6 | 7 | 8 | 9 | 10 |
| Rated power | 20 | 20 | 14 | 14 | 10 | 10 | 7.5 | 5.5 | 4 | 4 |
| No-load power | 3.45 | 3.45 | 2.82 | 2.82 | 1.58 | 1.58 | 0.84 | 0.55 | 1.8 | 1.8 |
| Setup time | 3 | 3 | 3 | 3 | 2 | 2 | 1 | 2 | 3 | 3 |

The workpieces to be processed include double-bottomed pot, stove top, right-angle adapter, cylindrical rod, cutter, and cover of kitchen hood. Each type of workpiece undergoes different processing processes and requires different processing times, demonstrating that a flexible manufacturing job shop is capable of processing small batches of parts with simple procedures and long processing times. The procedure information of hardware kitchenware workpieces produced in the job shop is shown in Table 2. The processing times for each procedure corresponding to the selectable processing robots are shown in Table 3.

TABLE 2
Procedure information of hardware kitchenware
workpieces produced in the job shop

| | Workpiece | | | | | |
|---|---|---|---|---|---|---|
| | | Grinding and | | | | |
| Procedure | Stamping | polishing | Welding | Cleaning | Painting | Packaging |
| Double- | 1 | 3 | 4 | 2 | — | 5 |
| bottomed pot | | | | | | |
| Stove top | 1 | 2 | — | — | 3 | 4 |
| Right-angle | 1 | 2 | 3 | — | 4 | — |
| adapter | | | | | | |
| Cylindrical rod | 1 | 2 | — | — | 3 | 4 |
| Cutter | 1 | 2 | — | 3 | — | 4 |
| Cover of | 1 | 4 | 3 | 2 | — | — |
| kitchen hood | | | | | | |

TABLE 3
Procedure processing time for workpieces
to be processed (unit time)

| Workpiece | Procedure | Processing robot | | | | | | | | | |
|---|---|---|---|---|---|---|---|---|---|---|---|
| number | number | M₁ | M₂ | M₃ | M₄ | M₅ | M₆ | M₇ | M₈ | M₉ | M₁₀ |
| J₁ | P₁₁ | 20 | 20 | \ | \ | \ | \ | \ | \ | \ | \ |
| | P₁₂ | \ | \ | \ | \ | \ | \ | 30 | \ | \ | \ |
| | P₁₃ | \ | \ | \ | \ | 40 | 40 | \ | \ | \ | \ |
| | P₁₄ | \ | \ | 30 | 30 | \ | \ | \ | \ | \ | \ |
| | P₁₅ | \ | \ | \ | \ | \ | \ | \ | \ | 20 | 20 |
| J₂ | P₂₁ | 30 | 30 | \ | \ | \ | \ | \ | \ | \ | \ |
| | P₂₂ | \ | \ | \ | \ | 50 | 50 | \ | \ | \ | \ |
| | P₂₃ | \ | \ | \ | \ | \ | \ | \ | 20 | \ | \ |
| | P₂₄ | \ | \ | \ | \ | \ | \ | \ | \ | 40 | 40 |
| J₃ | P₃₁ | 50 | 50 | \ | \ | \ | \ | \ | \ | \ | \ |
| | P₃₂ | \ | \ | \ | \ | 40 | 40 | \ | \ | \ | \ |
| | P₃₃ | \ | \ | 30 | 30 | \ | \ | \ | \ | \ | \ |
| | P₃₄ | \ | \ | \ | \ | \ | \ | \ | 50 | \ | \ |
| J₄ | P₄₁ | \ | \ | \ | \ | 70 | 70 | \ | \ | \ | \ |
| | P₄₂ | \ | \ | \ | \ | \ | \ | 50 | \ | \ | \ |
| | P₄₃ | \ | \ | \ | \ | \ | \ | \ | \ | 10 | 10 |

For easy calculation, both processing times and position coordinates of the processing robots are converted to unit time and unit distance. Each unit time is 4 min, every 20 unit distances represent 1 meter, and the transferring speed of AGV is 30 unit distances per unit time. The transferring time required for AGV transferring workpieces during the production and processing in the intelligent job shop is determined by the position of the processing robot, and the position coordinates of the processing robots are shown in Table 4.

TABLE 4
Position coordinates of processing robots (unit distance)

| Processing | | |
|---|---|---|
| robot number | X-coordinate | Y-coordinate |
| R₁ | 200 | 160 |
| R₂ | 440 | 160 |
| R₃ | 720 | 160 |
| R₄ | 960 | 160 |
| R₅ | 200 | 340 |
| R₆ | 440 | 340 |
| R₇ | 840 | 520 |
| R₈ | 320 | 520 |
| R₉ | 720 | 520 |
| R₁₀ | 960 | 640 |

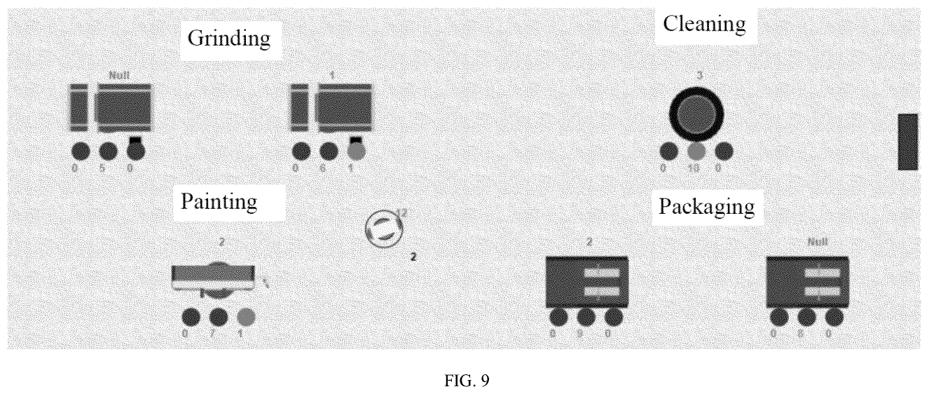

Each processing robot has two buffer areas and one processing area, as shown in FIG. 9. The first circle represents the buffer area for workpieces to be processed, the second circle represents the processing area, and the third circle represents the buffer area for the finished workpieces. The numbers indicate the number of occupied workpieces. As shown in this figure, the buffer area for finished workpieces of the painting robot has one occupied workpiece, and the cleaning robot is in the process of processing.

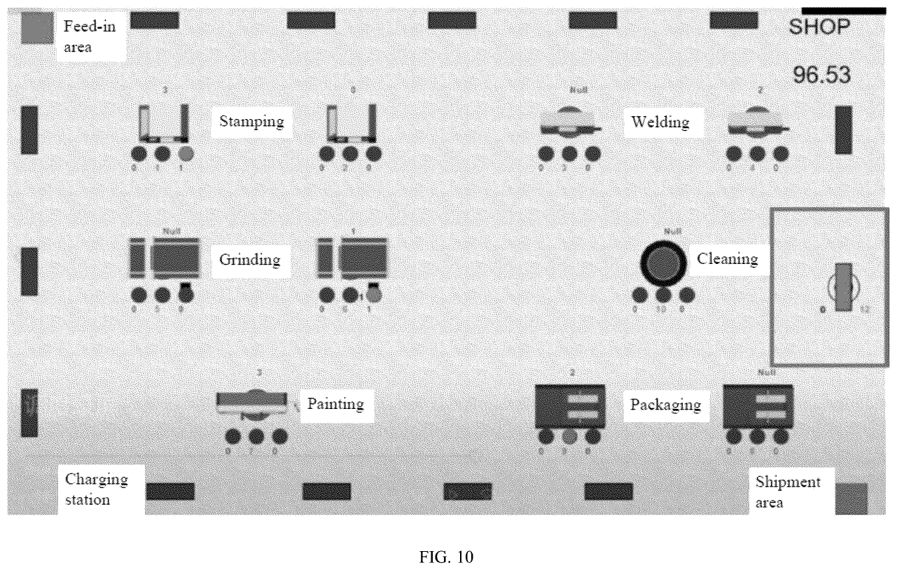

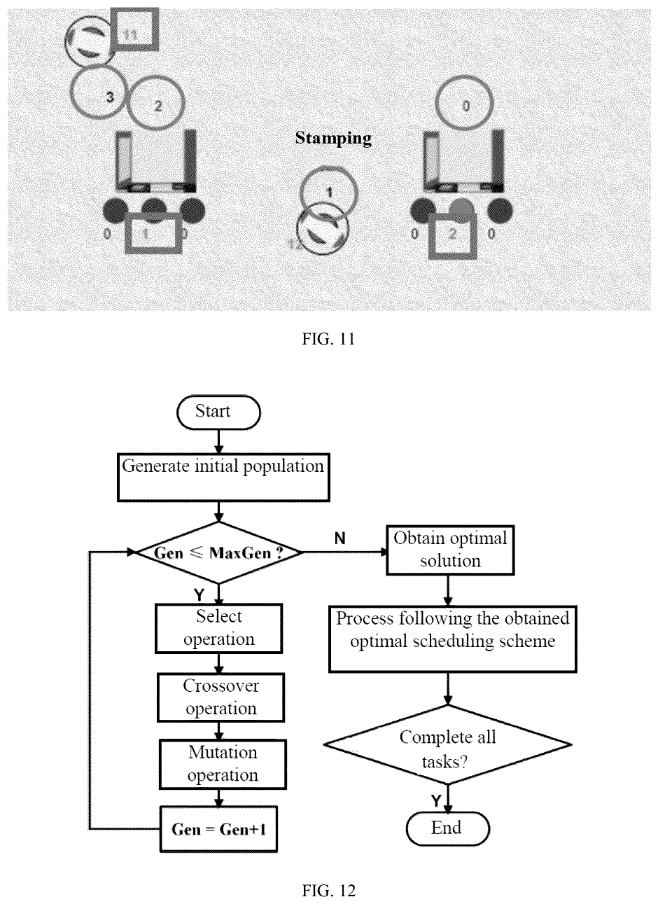

When the power level of an AGV drops below 40%, it will head to the nearest charging station for charging, as shown in FIG. 10, and the AGV will automatically leave once it is fully charged. The numbers above the AGVs and processing robots, as shown in the circles in FIG. 11, represent the numbers for workpieces being transferred/processed. The numbers below the AGVs and processing robots, as shown in the boxes in FIG. 11, represent the numbers for the processing robots and AGVs.

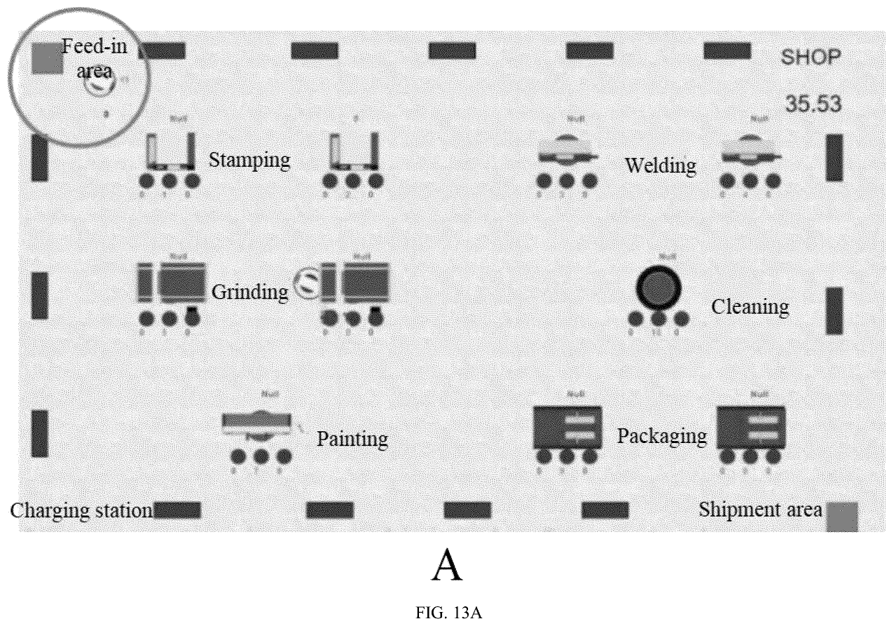

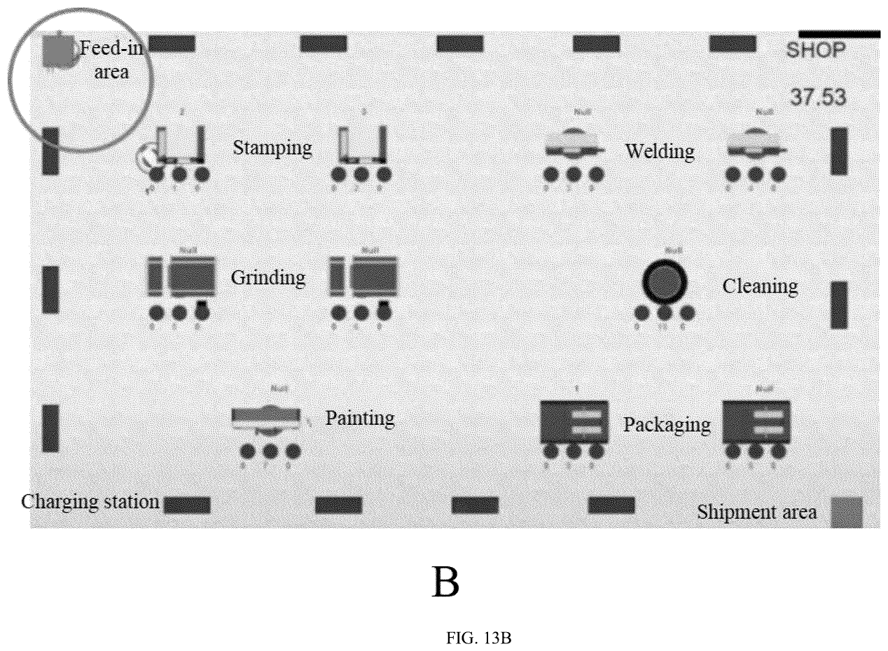

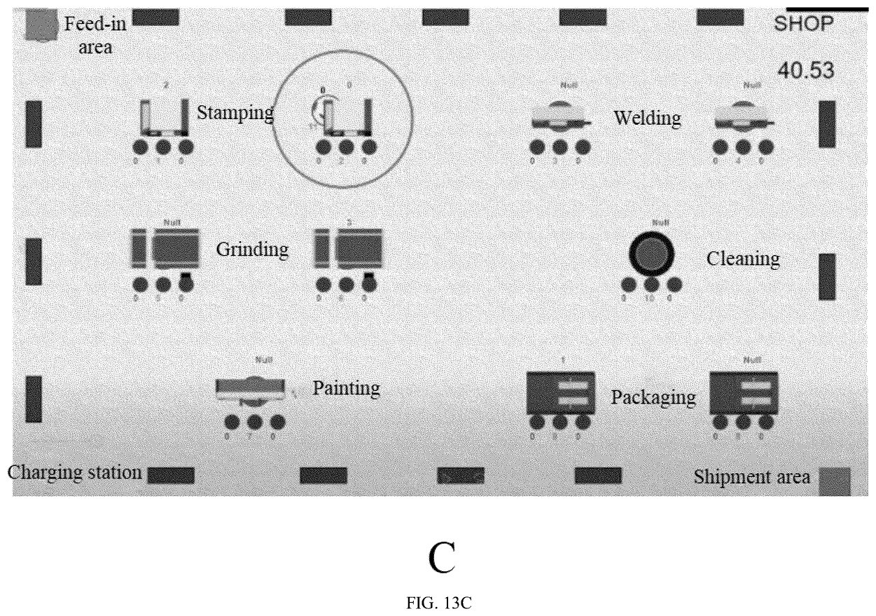

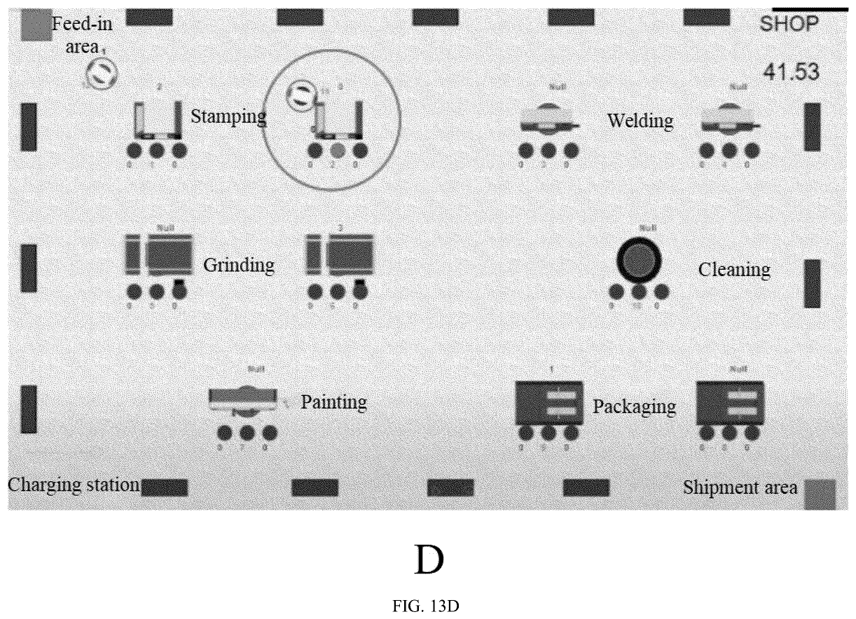

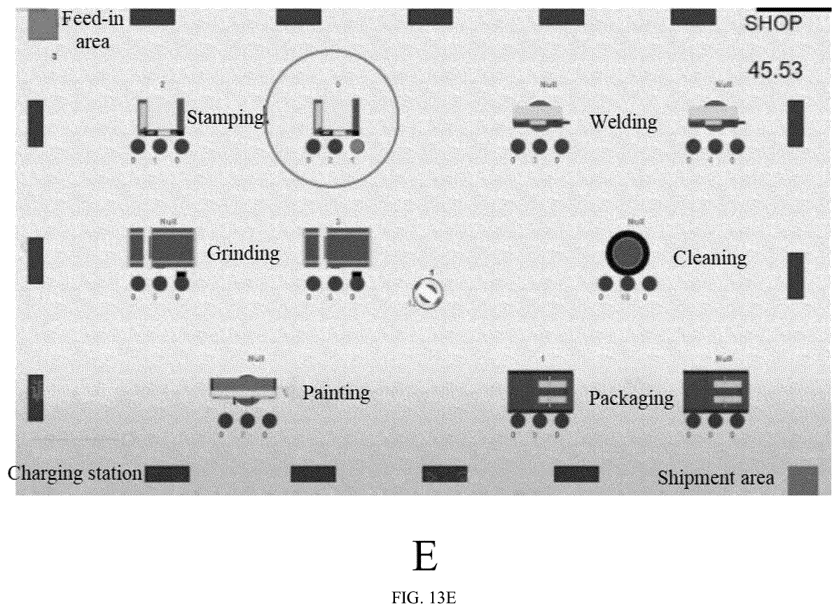

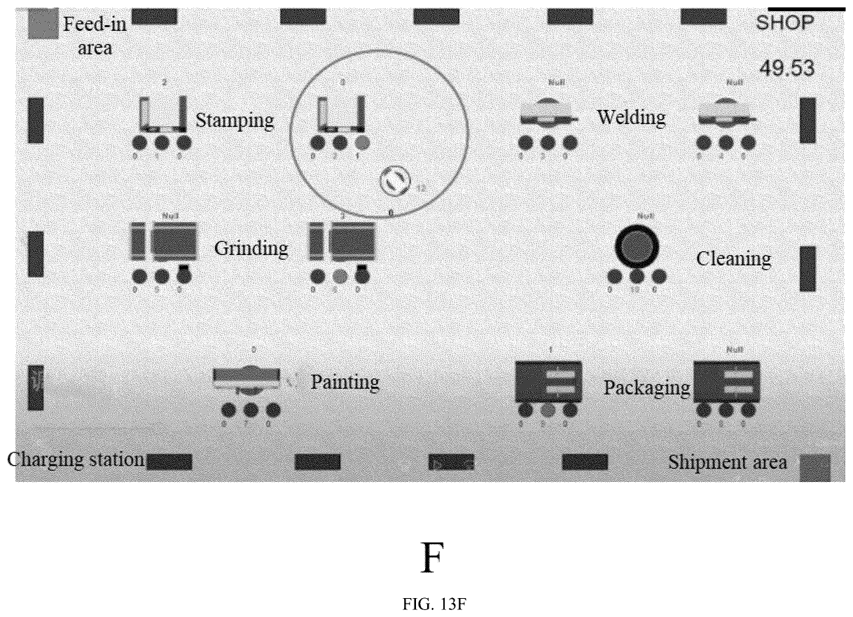

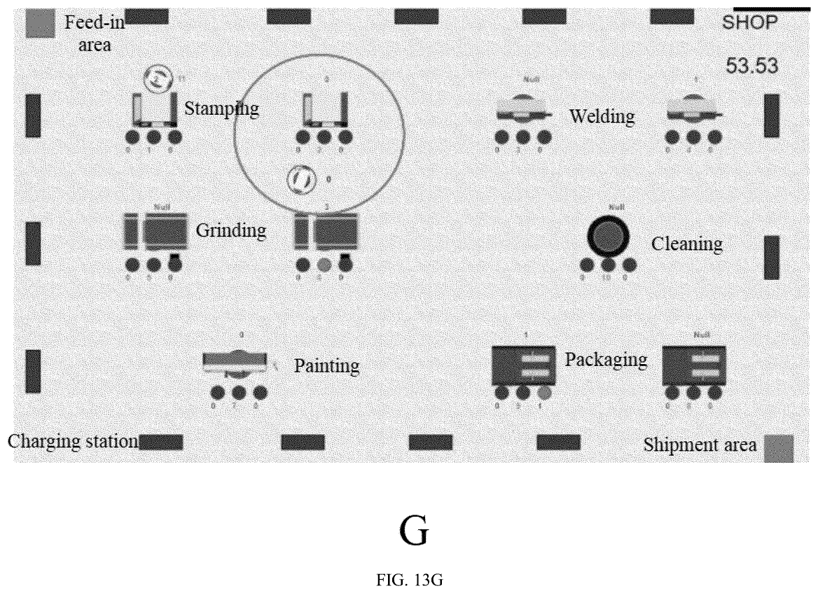

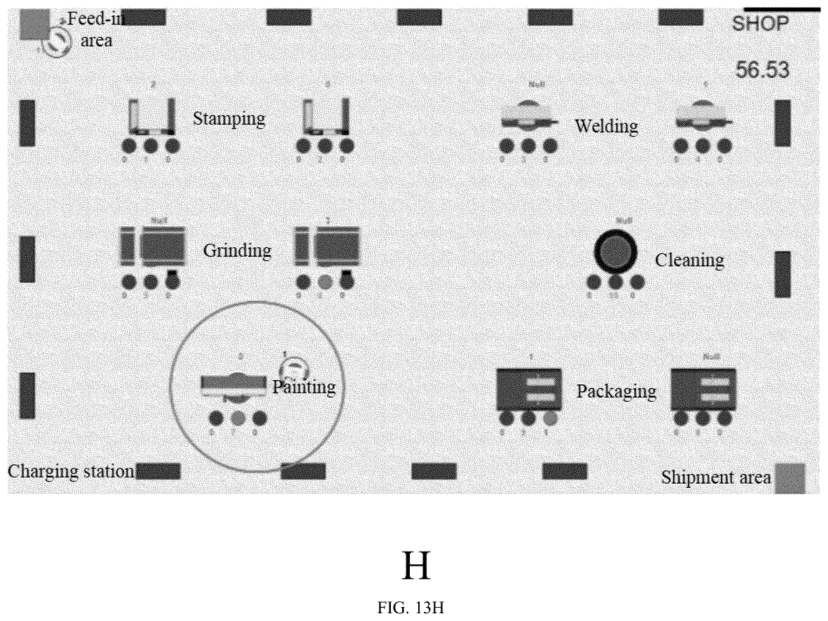

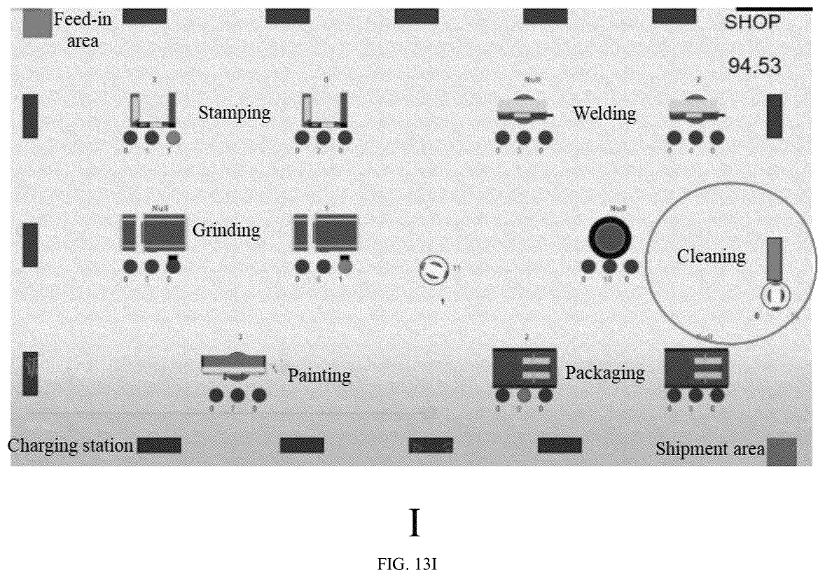

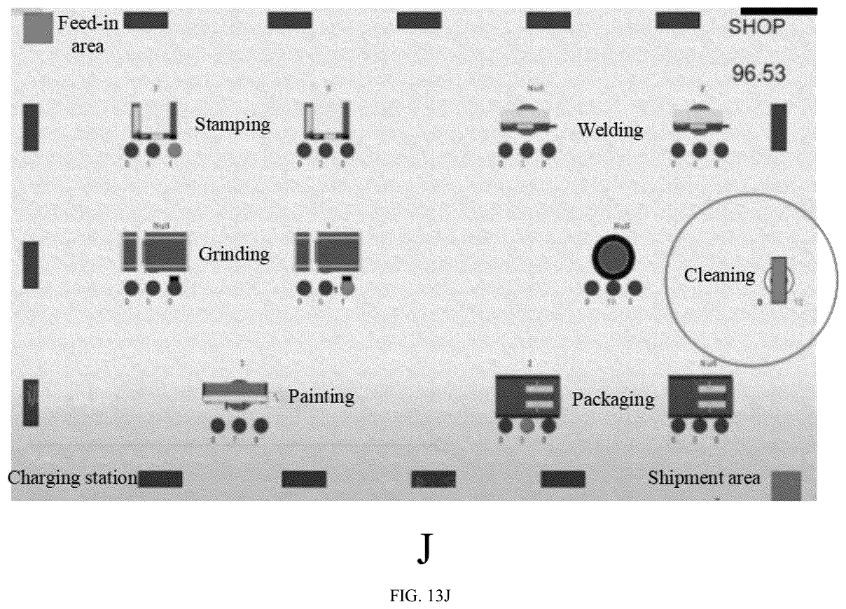

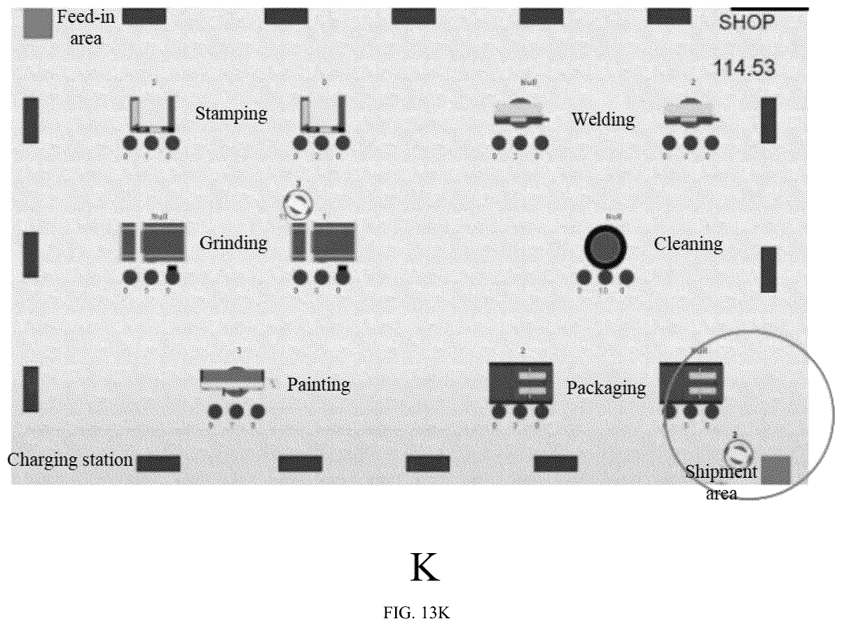

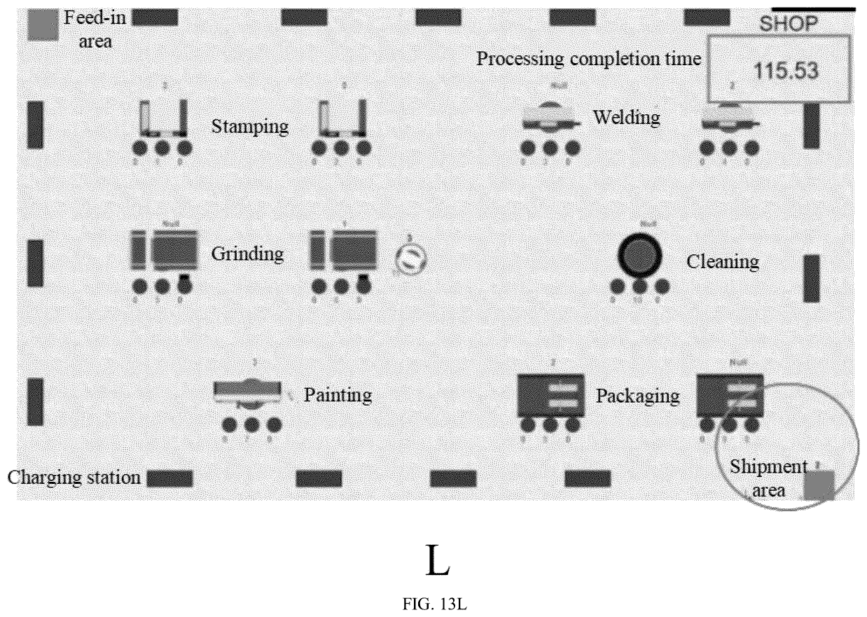

Taking the processing process of a small-scale job shop with four workpieces, ten processing robots, and two AGVs as the background, the designed genetic algorithm (with an online scheduling algorithm flowchart shown in FIG. 12 and relevant parameter settings shown in Table 5) is imported into the built job shop simulation and implemented to observe that the AGVs and processing robots complete processing tasks following the designed process of the scheduling scheme, as shown in FIG. 13A-FIG. 13L. In the present disclosure, the weight coefficients w of the fitness function are adjustable, with values of 0.2, 0.5, and 0.8 corresponding to the green processing mode, comprehensive processing mode, and efficient processing mode, respectively, for conducting three groups of experiments.

TABLE 5
Relevant parameter settings for job shop optimization
scheduling algorithm based on genetic algorithm

| | Symbolic | Value |
|---|---|---|
| Meaning of parameters | representation | set |
| Population size | PopSize | 100 |
| Number of iterations | MaxGen | 500 |
| Crossover probability | P_{c} | 0.95 |
| Mutation probability | Pₘ | 0.05 |
| Number of operations | num | 5 |

The dual-effect scheduling method is explained in conjunction with the simulation results.

FIG. 13A-FIG. 13L show the simulation results that the AGVs and processing robots complete processing tasks following the designed process of the scheduling scheme. FIG. 13A-FIG. 13H show the scheduling arrangement on the AGVs during the completion of a procedure Oᵢⱼ. FIG. 13I-FIG. 13J show the charging process of the AGV during transferring. When the AGV is charged, transferring tasks are paused, indicating that the charging time of the AGV also greatly affects the scheduling efficiency of the job shop. After the final procedure is completed, the AGV transfers the workpiece to the shipment area (shown in FIG. 13K-FIG. 13L), so that all processing tasks are completed.

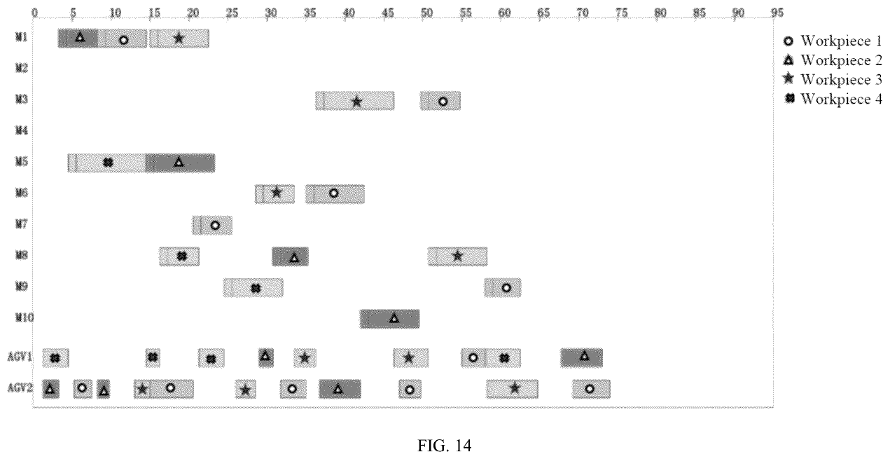

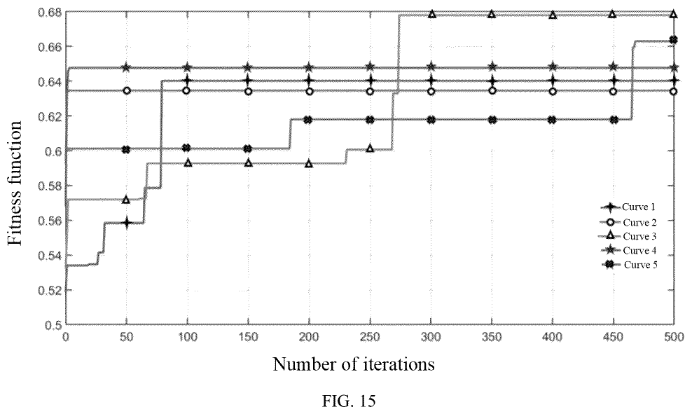

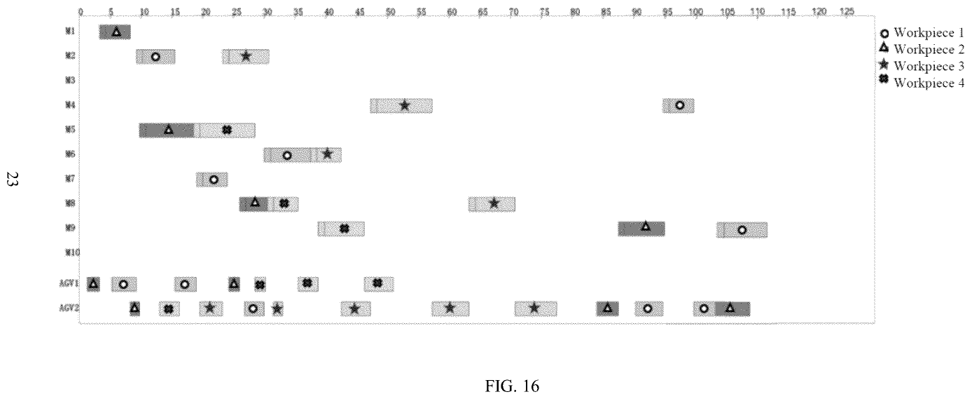

FIG. 14 shows a Gantt diagram for the efficient processing mode, where when ω=0.8, the completion time is the shortest and the completion efficiency is the highest. To increase the reliability of the results, each group of simulation is run five times, and curves showing the changes in fitness values over 500 iterations are plotted separately, as shown in FIG. 15. This figure shows that each test converges to near 0.65. Although the third test shows a slower convergence speed, it achieves a better final convergence effect, so it is selected as the optimal scheduling scheme. The results of the optimal scheduling scheme obtained by the job shop optimization scheduling algorithm based on the improved genetic algorithm running in AnyLogic simulation are shown in Table 6.

TABLE 6
Results of the optimal scheduling scheme based on the
improved genetic algorithm (ω = 0.8)

| | | | | Start | Completion |
|---|---|---|---|---|---|
| | | Selected | | time for | time for |
| | | processing | AGV | procedure | procedure |
| Workpiece | Procedure | robot | number | processing | processing |
| J₁ | P₁₁ | M₁ | R₂ | 33.54 | 58.54 |
| | P₁₂ | M₇ | R₂ | 82.16 | 102.16 |
| | P₁₃ | M₆ | R₂ | 140.67 | 170.67 |
| | P₁₄ | M₃ | R₂ | 199.11 | 219.11 |
| | P₁₅ | M₉ | R₁ | 232.94 | 250.94 |
| J₂ | P₂₁ | M₁ | R₂ | 13.54 | 33.54 |
| | P₂₂ | M₅ | R₂ | 58.15 | 93.15 |
| | P₂₃ | M₈ | R₁ | 123.55 | 141.55 |
| | P₂₄ | M₁₀ | R₂ | 168.92 | 198.92 |
| J₃ | P₃₁ | M₁ | R₂ | 60.69 | 90.69 |
| | P₃₂ | M₆ | R₂ | 114.16 | 134.16 |
| | P₃₃ | M₃ | R₁ | 145.26 | 185.26 |
| | P₃₄ | M₈ | R₁ | 203.19 | 233.19 |
| J₄ | P₄₁ | M₅ | R₁ | 18.15 | 58.15 |
| | P₄₂ | M₈ | R₁ | 65.36 | 85.36 |
| | P₄₃ | M₉ | R₁ | 98.69 | 128.69 |

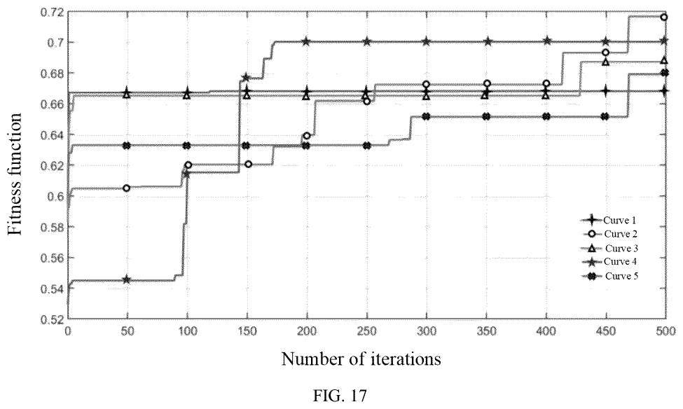

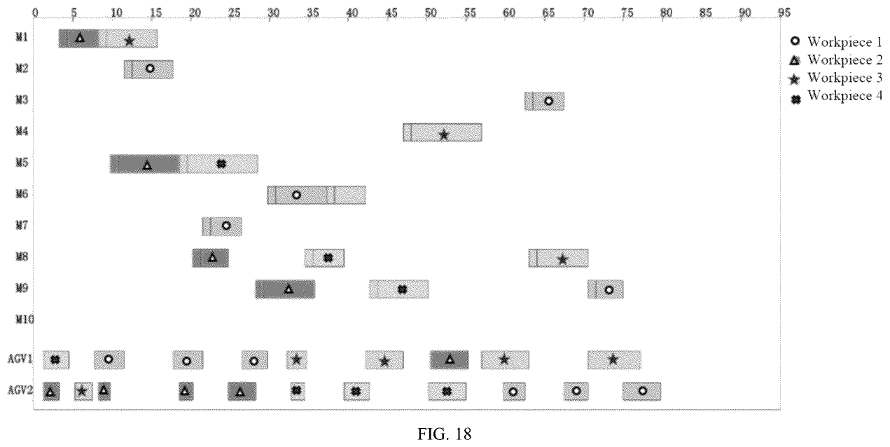

FIG. 16 is a Gantt diagram for the green processing mode, where when ω=0.2, the total energy consumption is minimized. To increase the reliability of the results, each group of simulation is run five times, and curves showing the changes in fitness values over 500 iterations are plotted separately, as shown in FIG. 17. It can be seen in the figure that each test converges to near 0.7, with a better convergence effect compared to that when ω=0.8, and the second test has the highest final fitness value, so it is selected as the optimal scheduling scheme. The results of the optimal scheduling scheme obtained by the job shop optimization scheduling algorithm based on the improved genetic algorithm running in AnyLogic simulation are shown in Table 7.

TABLE 7
Results of the optimal scheduling scheme based on the
improved genetic algorithm (ω = 0.2)

| | | | | Start | Completion |
|---|---|---|---|---|---|
| | | Selected | | time for | time for |
| | | processing | AGV | procedure | procedure |
| Workpiece | Procedure | robot | number | processing | processing |
| J₁ | P₁₁ | M₂ | R₁ | 37.14 | 62.41 |
| | P₁₂ | M₇ | R₁ | 76.76 | 96.76 |
| | P₁₃ | M₆ | R₂ | 120.95 | 150.95 |
| | P₁₄ | M₄ | R₂ | 379.44 | 399.44 |
| | P₁₅ | M₉ | R₂ | 413.86 | 413.86 |
| J₂ | P₂₁ | M₁ | R₁ | 13.54 | 33.54 |
| | P₂₂ | M₅ | R₂ | 39.54 | 74.54 |
| | P₂₃ | M₈ | R₁ | 81.75 | 99.75 |
| | P₂₄ | M₉ | R₂ | 121.45 | 151.45 |
| J₃ | P₃₁ | M₂ | R₂ | 44.14 | 74.14 |
| | P₃₂ | M₆ | R₂ | 129.95 | 149.95 |
| | P₃₃ | M₄ | R₂ | 281.98 | 321.98 |
| | P₃₄ | M₈ | R₂ | 339.91 | 369.91 |
| J₄ | P₄₁ | M₅ | R₂ | 74.54 | 114.54 |
| | P₄₂ | M₈ | R₂ | 134.21 | 154.21 |
| | P₄₃ | M₉ | R₁ | 202.11 | 264.54 |

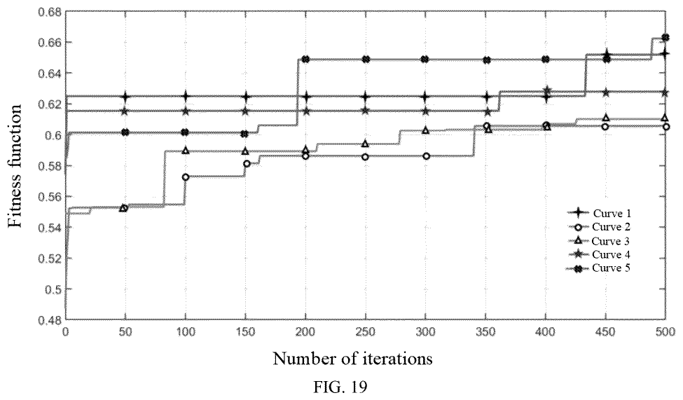

FIG. 18 shows a Gantt diagram for the comprehensive processing mode, where when ω=0.5, both total energy consumption and completion time are considered. To increase the reliability of the results, each group of simulation is run five times, and curves showing the changes in fitness values over 500 iterations are plotted separately, as shown in FIG. 19. The figure shows that each test converges to near 0.6, and the fifth test exhibits a rapid convergence speed and good convergence effect, so it is selected as the optimal scheduling scheme. The results of the optimal scheduling scheme obtained by the job shop optimization scheduling algorithm based on the improved genetic algorithm running in AnyLogic simulation are shown in Table 8.

TABLE 8
Results of the optimal scheduling scheme based on the
improved genetic algorithm (ω = 0.5)

| | | | | Start | Completion |
|---|---|---|---|---|---|
| | | Selected | | time for | time for |
| | | processing | AGV | procedure | procedure |
| Workpiece | Procedure | robot | number | processing | processing |
| J₁ | P₁₁ | M₂ | R₁ | 46.75 | 71.75 |
| | P₁₂ | M₇ | R₁ | 86.38 | 106.38 |
| | P₁₃ | M₆ | R₂ | 119.71 | 149.71 |
| | P₁₄ | M₃ | R₂ | 250.98 | 270.98 |
| | P₁₅ | M₉ | R₂ | 282.98 | 300.98 |
| J₂ | P₂₁ | M₁ | R₂ | 13.54 | 33.54 |
| | P₂₂ | M₅ | R₂ | 39.54 | 74.54 |
| | P₂₃ | M₈ | R₂ | 81.75 | 99.75 |
| | P₂₄ | M₉ | R₂ | 113.08 | 143.08 |
| J₃ | P₃₁ | M₁ | R₂ | 33.54 | 63.54 |
| | P₃₂ | M₆ | R₁ | 149.71 | 169.71 |
| | P₃₃ | M₄ | R₁ | 188.05 | 228.05 |
| | P₃₄ | M₈ | R₁ | 252.53 | 282.53 |
| J₄ | P₄₁ | M₅ | R₁ | 74.54 | 114.54 |
| | P₄₂ | M₈ | R₂ | 138.55 | 158.55 |
| | P₄₃ | M₉ | R₂ | 171.89 | 201.89 |

Table 9 shows the final operation results for the three modes. It can be seen from the table that as the value of w increases, the completion time for processing is prolonged, and the total energy consumption is decreased. The value obtained from the optimal scheduling scheme is not much different from the average value, indicating that the corresponding algorithm has a better convergence.

TABLE 9
Results of the optimal scheduling scheme based on
the improved genetic algorithm (unit time, kJ)

| | Efficient | Comprehensive | Green |
|---|---|---|---|
| | processing | processing | processing |
| | mode | mode | mode |
| Average completion | 328.24 | 349.94 | 418.68 |
| time | | | |
| Average total energy | 2006.33 | 1981.07 | 1803.25 |
| consumption | | | |
| Completion time of | 296.381 | 319.67 | 468.38 |
| optimal scheduling | | | |
| Total energy | 1778.32 | 1876.32 | 1755.05 |
| consumption of | | | |
| optimal scheduling | | | |

The embodiment disclosed above is implemented according to the technical solutions of the present disclosure, and detailed implementation and specific operation processes are provided, but the scope of protection of the present disclosure is not limited to the forgoing embodiment. It can be known from the above description that the present disclosure can be modified and substituted in many aspects. The specific values fixed in this embodiment are solely for the purpose of better illustrating the principles and applications of the present disclosure, thereby facilitating easier understanding and implementation. Any local modifications, equivalents and improvements made on the basis of the technical solutions of the present disclosure are included in the scope of protection of the present disclosure.

1. A dual-effect scheduling method for heterogeneous robots in a flexible job shop, comprising the following steps:
step 1: encoding each individual in three layers using a symbolic coding method, the encoding of each individual comprising three layers, namely, workpiece procedure-based encoding, processing robot-based encoding, and automated guided vehicle (AGV)-based encoding,
step 2: acquiring processing robot information, AGV information and to-be-processed workpiece information, integrating two objective functions for respectively minimizing order completion time and minimizing resource consumption into a single composite function using a weighted optimization method, and designing a fitness function,
step 3: calculating fitness of each individual encoded in step 1 using the fitness function designed in step 2, and selecting individuals for the next generation according to fitness values using a roulette wheel selection method with an elitism strategy,
step 4: performing crossover operation on the workpiece procedure-based encoding and the AGV-based encoding of the individual in step 1 using precedence operation crossover (POX), and performing two-point crossover operation on the processing robot-based encoding of the individual,
step 5: performing swap mutation operation on the workpiece procedure-based encoding and the AGV-based encoding of the individual in step 1, and performing uniform mutation operation on the processing robot-based encoding of the individual, and
step 6: together forming the individual selected in step 3, the individual after the crossover operation in step 4, and the individual after the mutation operation in step 5 into a new population for the next generation, repeating steps 3 to 5 for individuals in the new population for the next generation to obtain optimal scheduling schemes and fitness values, and selecting a suitable scheduling scheme according to the demand preferences to perform dual-effect scheduling on heterogeneous robots in a flexible job shop, wherein
in step 1, the first layer of encoding is based on workpiece procedure, for clarifying the order of various workpieces and various procedures in a processing scheme; each gene of the individual represents a specific procedure of a specific workpiece; various procedures of a workpiece are represented by the order in which the workpiece appears in the individual; and the nₜₕ presence of a specific workpiece in the individual represents the nₜₕ procedure of the specific workpiece;
the second layer of encoding is based on processing robot, for clarifying the order of selected processing robots corresponding to various procedures of workpieces in the processing scheme; each gene of the individual represents a corresponding processing robot selected for a specific procedure of a specific workpiece; and the order of genes follows the order of processing workpiece numbers and the order of procedure numbers of a specific workpiece; and
the third layer of encoding is based on AGV, for clarifying the order of AGVs corresponding to various workpiece procedures in the processing scheme; each gene of the individual represents an AGV number corresponding to a specific procedure of transferring a specific workpiece; and the order of genes corresponds to the order of the workpiece procedure-based encoding;
in step 2, the processing robot information comprises: the number of processing robots, the process processing capability of processing robots, and fixed-point positions of processing robots; the AGV information comprises: the number of AGVs, the running speed of AGVs, and initial positions of AGVs; and the to-be-processed workpiece information comprises: the number of workpieces to be processed, the number of procedures of the workpieces to be processed, and available processing robots and processing time for each procedure; and the fitness function is defined as:
$$F ( k ) = ω \times \frac{{f}_{1 m ax} - {f}_{1} ( k )}{{f}_{1 m ax} - {f}_{1 m i n}} + ( 1 - ω ) \frac{{f}_{2 m ax} - {f}_{2} ( k )}{{f}_{2 m ax} - {f}_{2 m i n}} , ( k = 1 , 2 , … , N )$$
where F(k) is a fitness value of a kₜₕ individual; ω is a weight coefficient for completion time, ranging from [0,1], and the allocation of weight is determined by a decision-maker of a job shop; in a case that 0.6≤ω≤1, the job shop operates in an efficient processing mode; in a case that 0.4≤ω≤0.6, the job shop operates in a comprehensive processing mode; and in a case that 0.2≤ω≤0.4, the job shop operates in a green processing mode; f₁ₘₐₓ is a maximum order completion time in a job shop of a current population; f₁(k) is an order completion time in a job shop of the kₜₕ individual; f₁ₘᵢₙ is a minimum order completion time in the job shop of the current population; f₂ₘₐₓ is a maximum energy consumption of the current population; f₂(k) is energy consumption of the kₜₕ individual; f₂ₘᵢₙ is a minimum energy consumption of the current population; and N is the total number of individuals in the current population;
in step 3, individuals with the highest fitness values in the current population are elite individuals; the first quarter of individuals with the highest fitness values in the current population are kept from undergoing the roulette wheel selection, and the remaining three-quarters undergo the roulette wheel selection, crossover, and mutation to generate a new generation of population; and if a fitness value of an optimal individual in the new generation of population is better than that of a reserved parent, it indicates that the population has been optimized, and the worst individual in offspring is replaced with the reserved elite individual;
in step 4, a method for performing crossover operation on the workpiece procedure-based encoding of the individual using POX is as follows:
randomly dividing all workpieces into two sets Q₁ and Q₂; copying workpieces of parent P₁ that are contained in Q₁ to corresponding positions in an offspring individual C₁, copying workpieces of parent P₂ that are contained in Q₂ to corresponding positions in an offspring individual C₂, and fixing the position of each gene in the individual; and copying workpieces of the parent P₂ that are contained in Q₂ to corresponding positions in the offspring individual C₁, and copying workpieces of the parent P₁ that are contained in Q₁ to corresponding positions in the offspring individual C₂, and keeping the order of genes to obtain two offspring individuals C₁ and C₂ after crossover;
in step 4, a method for performing crossover operation on the AGV-based encoding of the individual using POX is as follows:
randomly dividing all AGVs into two sets Q₁ and Q₂; copying workpieces of parent P₁ that are contained in Q₁ to corresponding positions in an offspring individual C₁, copying workpieces of parent P₂ that are contained in Q₂ to corresponding positions in an offspring individual C₂, and fixing the position of each gene in the individual; and copying workpieces of the parent P₂ that are contained in Q₂ to corresponding positions of the offspring individual C₁, and copying workpieces of the parent P₁ that are contained in Q₁ to corresponding positions of the offspring individual C₂, keeping the order of genes to obtain two offspring individuals C₁ and C₂ after crossover;
in step 4, a method for performing two-point crossover operation on the processing robot-based encoding of the individual is as follows:
selecting two different points p₁ and p₂ as crossover points, and swapping genes g₁ and g₂ in p₁ and p₂ of two individuals, respectively;
in step 5: a method for performing swap mutation operation on the workpiece procedure-based encoding of the individual is as follows: selecting two different random numbers within the length of two procedures, and swapping genes of the two procedures;
a method for performing swap mutation operation on the AGV-based encoding is as follows: selecting two different random numbers within the length of two AGVs, and swapping genes of the two AGVs; and
a method for performing uniform mutation operation on the processing robot-based encoding of the individual is as follows: randomly selecting a procedure, directly returning without changing the gene if only one machine is selectable for the procedure, otherwise, randomly generating a serial number different from the currently selected machine within a selectable machine set of the procedure, and performing swap; and
in step 6, a suitable scheduling scheme is selected according to demand preferences, the demand preference referring to the balance between the two objectives of order completion time and energy consumption, a desired scheme is selected and implemented, and a method for obtaining the optimal scheduling scheme is as follows: gradually iterating, and obtaining the optimal scheduling scheme in a case that the change in fitness values is less than a set threshold or the number of generations is greater than the set number of iterations.
